(19) United States
(12) Patent Application Publication
(10) Pub. No.: US 2011/0080500 A1
(43) Pub. Date: Apr. 7, 2011

(54) IMAGING TERMINAL, IMAGING SENSOR HAVING MULTIPLE RESET AND/OR MULTIPLE READ MODE AND METHODS FOR OPERATING THE SAME

(75) Inventors: Ynjiun P. Wang, Cupertino, CA (US); Isaac Cohen, Minnetonka, MN (US); Scott McCloskey, Minneapolis, MN (US)

(73) Assignee: Hand Held Products, Inc., Skaneateles Falls, NY (US)

(21) Appl. No.: 12/573,663

(22) Filed: Oct. 5, 2009

(51) Int. Cl. H04N 5/76; H04N 5/228

(52) U.S. Cl. 348/231.3; 348/222.1; 348/E05.031

(57) ABSTRACT

There is described in one embodiment an indicia reading terminal having an image sensor pixel array incorporated therein, where the terminal is operative for decoding of decodable indicia and for providing frames of image data (e.g., color) for storage, display, or transmission. Embodiments of imaging terminals, image sensor arrays and methods for operating the same can controllable process an integration period to improve pixel, image sensor, or imaging terminal performance.

### FIELD OF THE INVENTION

The application relates to data terminals in general and more specifically to image sensor based data terminals capable of obtaining decodable indicia and frames of image data.

### BACKGROUND OF THE INVENTION

Image sensor based terminals are known to be used in industrial data collection applications. Image sensor based indicia reading terminals have been used for a number of years for purposes of decoding information encoded in bar code symbols. For decoding of a bar code symbol, images captured with use of an image sensor based terminal are subject to processing by application of one or more bar code decoding algorithms. Recently, by using color image sensors in the Automatic Identification and Data Capture (AIDC) industry, high quality color images/videos can be captured and stored to meet the growing needs of scanner customers. However, additional capabilities or functions can increase image quality, increase data read rates, or improve data capture.

### SUMMARY OF THE INVENTION

There is described in one embodiment an indicia reading terminal having an image sensor pixel array incorporated therein, wherein the terminal is operative for decoding of decodable indicia and for providing frames of image data for storage, display, or transmission.

An imaging terminal in one embodiment can operate to capture a plurality of representations of a frame of image in a single integration period.

An imaging terminal in one embodiment can be operative to capture a plurality of frames of image data in a single exposure period.

An imaging terminal in one embodiment can include an image sensor having a hybrid monochrome and color image sensor pixel array that includes a first subset of monochrome pixels and a second subset of color pixels.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 is a schematic diagram illustrating an imaging terminal in one embodiment;

FIG. 2 is a diagram illustrating an exemplary hybrid monochrome and color image sensor pixel array having a first subset of monochrome pixels and a second subset of color pixels;

FIG. 3 is a block diagram illustrating an imaging terminal in one embodiment;

FIG. 4 is a perspective physical form view of an exemplary imaging terminal including a hand held housing;

FIG. 5 is a diagram illustrating exemplary timing for operations of an image sensor;

FIG. 6 is a diagram illustrating timing for operations of an embodiment of an image sensor according to the application;

FIG. 7A is a diagram illustrating exemplary timing for operations of an embodiment of an image sensor according to the application;

FIG. 7B is a diagram illustrating exemplary timing for operations of an embodiment of an image sensor according to the application;

FIG. 8A is a diagram illustrating timing for operations of an embodiment of an image sensor according to the application;

FIG. 8B is a diagram illustrating timing for operations of an embodiment of an image sensor according to the application;

FIG. 9 is a block diagram illustrating an exemplary embodiment of a pixel configuration for an image sensor; and

FIG. 10 is a flow diagram illustrating an exemplary embodiment of a method of operating an imaging terminal according to the application.

### DETAILED DESCRIPTION OF THE EMBODIMENTS

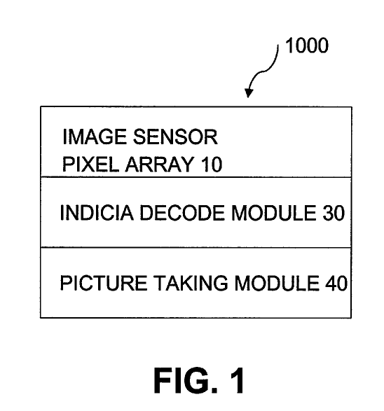

Referring to FIG. 1, an imaging terminal 1000 can be provided having a monochrome image sensor pixel array 10. Terminal 1000 can also include an indicia decode module 30 for configuring terminal 1000 to operate in an indicia decode operating mode and a picture taking module 40 for configuring terminal 1000 to operate in a picture taking mode.

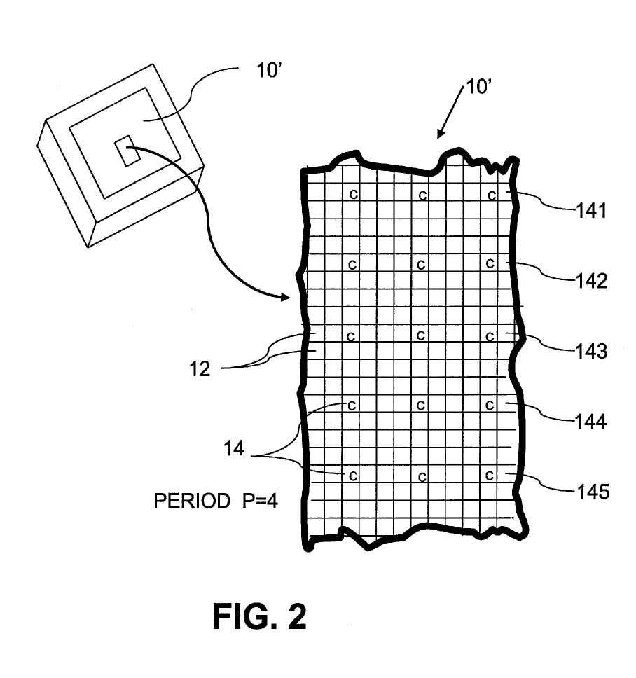

Referring to FIG. 2, an imaging terminal 1000 can be provided having a hybrid monochrome and color image sensor pixel array 10′, wherein the image sensor pixel array has a first subset of monochrome pixels and a second subset of color pixels. Hybrid monochrome and color image sensor pixel array 10′ can include pixels arranged in a plurality of rows of pixels and can include a first subset of monochrome pixels 12 devoid of color filter elements and a second subset of color pixels 14 including color filter elements. Such color sensitive pixels can be disposed at spaced apart positions of an image sensor pixel array 10′ and can be disposed at positions uniformly or substantially uniformly throughout an image sensor pixel array 10. In one embodiment, the spaced apart color pixels of the image sensor array, though spaced apart can follow a pattern according to a Bayer pattern. For example, where Red=R, Green=G, and Blue=B, the color pixels shown in row 141 can have the pattern . . . GRGRGRG . . . which pattern can be repeated for rows 145 and 143. The pixels of row 142 can have the pattern . . . BGBGBGB . . . , which pattern can be repeated for row 144. The patterns described with reference to rows 141, 142, 143, 144, 145 can be repeated throughout image sensor pixel array 10. Alternatively, different patterns for the color pixels may be used in accordance with principle of the invention. A color frame of image data captured with use of a color image sensor pixel array 10 having both color and monochrome pixels can include monochrome pixel image data and color pixel image data. Various additional features that can be utilized with imaging terminal 1000 are disclosed in U.S. patent application Ser. No. 11/174,447 entitled, Digital Picture Taking Optical Reader Having Hybrid Monochrome And Color Image Sensor Array, filed Jun. 30, 2005, incorporated herein by reference. Color sensitive pixels may be distributed in the array in a specific pattern of uniform distribution such as a period of P=4 where, for every fourth row of pixels of the array, every fourth pixel is a color sensitive pixel as shown in FIG. 2. However, other uniform (e.g., P=2) or non-uniform spatial distributions of color sensitive pixels may be used.

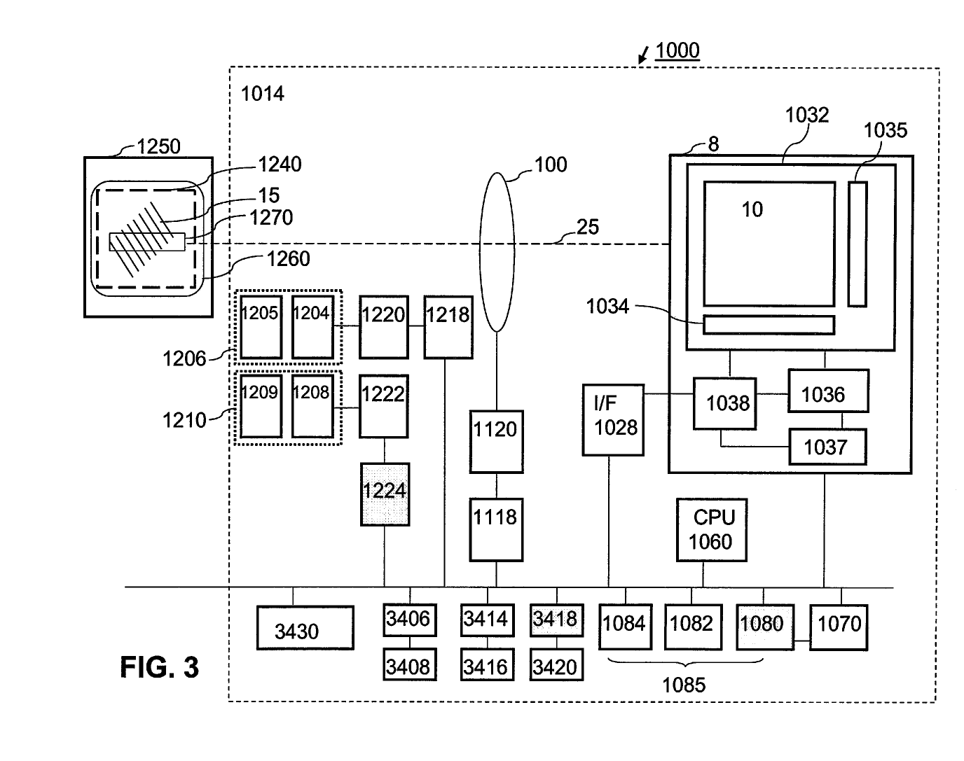

A block diagram illustrating an imaging terminal 1000 in one embodiment is shown in FIG. 3. Imaging terminal 1000 can include image sensor 8 having image sensor circuit 1032 comprising a multiple pixel image sensor pixel array 10 having pixels arranged in rows and columns of pixels, associated column circuitry 1034 and row circuitry 1035. Associated with the image sensor circuit 1032 can be amplifier circuit 1036, and an analog to digital converter 1037 that converts image information in the form of analog signals read out of image sensor circuit pixel array 10 into image information in the form of digital signals. Image sensor circuit 1032 can also have an associated timing and control circuit 1038 for use in controlling e.g., the exposure period of image sensor circuit 1032, gain applied to the amplifier circuit 1036. The noted circuit components 1032, 1036, 1037, and 1038 that make up image sensor 8 or a subset of the components 1032, 1036, 1037, 1038 can be packaged into a common image sensor integrated circuit. In one example, image sensor 8 can be provided by monochrome MT9V022 image sensor integrated circuit available from Micron Technology, Inc., which can also be modified to include color filters disposed on a subset of pixels of image sensor pixel array 10′ to define a hybrid monochrome and color image sensor pixel array as described herein.

In the course of operation of terminal 1000 image signals can be read out of image sensor circuit 1032, amplified by amplifier circuit 1036, converted by analog to digital converter 1037, and stored into a system memory such as RAM 1080. A set of image data corresponding to pixels of image sensor pixel array 10 can be regarded as a frame of image data. A memory 1085 of terminal 1000 can include RAM 1080, a nonvolatile memory 1082 such as may be provided by EPROM and a storage memory device 1084 such as may be provided by a flash memory or a hard drive memory. In one embodiment, terminal 1000 can include CPU 1060 that can be adapted to read out stored image data (e.g., memory 1085) and subject such image data to various image processing algorithms. Terminal 1000 can include a direct memory access unit (DMA) 1070 for routing image information read out from image sensor pixel array 10 that has been subject to conversion to RAM 1080. In another embodiment, terminal 1000 can employ a system bus providing for bus arbitration mechanism (e.g., a PCI bus) thus eliminating the need for a central DMA controller. A skilled artisan would appreciate that other embodiments of the system bus architecture and/or direct memory access components providing for efficient data transfer between the image sensor circuit 1032, memory 1085 (e.g., RAM 1080) and/or CPU 1060 are within the scope and the spirit of the application.

Terminal 1000 can be operative so that terminal 1000 can capture a succession of frames by storage of the frames in memory 1080 where the frames are addressable for processing by CPU 1060. Terminal 1000 can be operative so that the capture and/or processing of the succession of frames is responsive to activation of a trigger signal. Terminal 1000 can be operative so that such trigger signal can be activated when an operator actuates a trigger of terminal 1000.

Referring to further aspects of terminal 1000, lens assembly 100 can be adapted for use in focusing an image of a decodable indicia 15 located within a field of view 1240 on an object 1250 onto image sensor pixel array 10. Imaging light rays can be transmitted to impinge on array 10, for example, about imaging axis 25. Lens assembly 100 can be adapted to be capable of multiple focal lengths and multiple best focus distances. Terminal 1000 can include more than one lens assembly 100, which can be configured for different characteristics such as focal lengths.

Terminal 1000 can also include an illumination pattern light source bank 1204 and associated light shaping optics 1205 for generating an illumination pattern 1260 substantially corresponding to a field of view 1240 of terminal 1000. The combination of bank 1204 and optics 1205 can be regarded as an illumination pattern generator 1206. Terminal 1000 can also include an aiming pattern light source bank 1208 and associated light shaping optics 1209 for generating an aiming pattern 1270 on object 1250. The combination of bank 1208 and optics 1209 can be regarded as an aiming pattern generator 1210. In use, terminal 1000 can be oriented by an operator with respect to a object 1250 bearing decodable indicia 15 in such manner that aiming pattern 1270 is projected on a decodable indicia 15. In the example of FIG. 3, decodable indicia 15 is provided by a 1D bar code symbol. Decodable indicia 15 could also be provided by a 2D bar code symbols or optical character recognition (OCR) characters.

Each of illumination pattern light source bank 1204 and aiming pattern light source bank 1208 can include one or more light sources. Lens assembly 100 can be controlled with use of lens assembly control unit 1120. Illumination pattern light source bank 1204 can be controlled with use of illumination pattern light source control circuit 1220. Aiming pattern light source bank 1208 can be controlled with use of aiming pattern light source bank control circuit 1222. Lens assembly control unit 1120 can output signals for control of lens assembly 100, e.g., for changing a focal length and/or a best focus distance of (e.g., a plane of optical focus of) lens assembly 100. Illumination pattern light source bank control circuit 1220 outputs signals for control of illumination pattern light source bank 1204, e.g., for changing a level of illumination output by illumination pattern light source bank 1204. Aiming pattern light source bank control circuit 1222 can output signals to aiming pattern light source bank 1208, e.g., for changing a level of illumination output by aiming pattern light source bank 1208.

Terminal 1000 can also include a number of peripheral devices including trigger 3408 that may be used to make active a trigger signal for activating frame readout and/or certain decoding processes. Terminal 1000 can be adapted so that actuation of trigger 3408 activates a trigger signal and initiates a read attempt. For example, terminal 1000 can be operative so that in response to activation of a trigger signal, a succession of frames can be captured by way of read out of image information from image sensor pixel array 10 and then storage of the image information after conversion into memory 1085 (e.g., memory 1080 that can buffer one or more of the succession of frames at a given time). CPU 1060 can be operative to subject one or more of the succession of frames to a read (e.g., decode) attempt. For attempting to read a bar code symbol, CPU 1060 can process image data of a frame corresponding to a line of pixel positions (e.g., a column of pixel positions, a row of pixel positions, or a diagonal line of pixel positions) to determine a spatial pattern of dark and light cells and can convert each light and dark cell pattern determined into a character or character string via table lookup, to determine and output a message (e.g., display). By being operative to process a frame (e.g., of image data) for attempting to decode a decodable indicia, terminal 1000 can be regarded as including indicia decode operating mode. Operating with an indicia decode operating mode active, terminal 1000 can be operative to process a frame of image data for decoding the frame, and can further be operative for outputting a decoded message.

Terminal 1000 can include various interface circuits for coupling various of the peripheral devices to system address/data bus (system bus) 1500 for communication with CPU 1060, also coupled to system bus 1500. Terminal 1000 can include interface circuit 1028 for coupling image sensor timing and control circuit 1038 to system bus 1500, interface circuit 1118 for coupling lens assembly control unit 1120 to system bus 1500, interface circuit 1218 for coupling light source bank control circuit 1220 to system bus 1500, interface circuit 1224 for coupling aiming light source bank control circuit 1222 to system bus 1500, and interface circuit 3406 for coupling trigger 3408 to system bus 1500.

Terminal 1000 can also include a display 3420 for displaying such information as image frames captured with the use of terminal 1000 that is coupled to system bus 1500 and in communication with CPU 1060, via interface 3418, as well as pointer mechanism 3416 in communication with CPU 1060 via interface 3414 connected to system bus 1500.

In a further aspect, imaging terminal 1000 can include one or more communication interfaces 3430 that can include any transceiver like mechanism to enable terminal 1000 to communicate with other spaced apart devices or external devices (e.g., using wired, wireless or optical connections). Exemplary external devices can include a cash register server, a store server, an inventory facility server, a peer terminal 1000, a local area network base station, a cellular base station. Interfaces 3430 can be I/O interfaces of any combination of known computer interfaces, e.g., Ethernet (IEEE 802.3), USB, IEEE 802.11, Bluetooth, CDMA, GSM. Communication interface 3430 can be a radio frequency (RF) communication interface that can include one or more radio transceivers such as one or more of 802.11 radio transceiver, Bluetooth radio transceiver, GSM/GPS radio transceiver or WIMAX (802.16) radio transceiver.

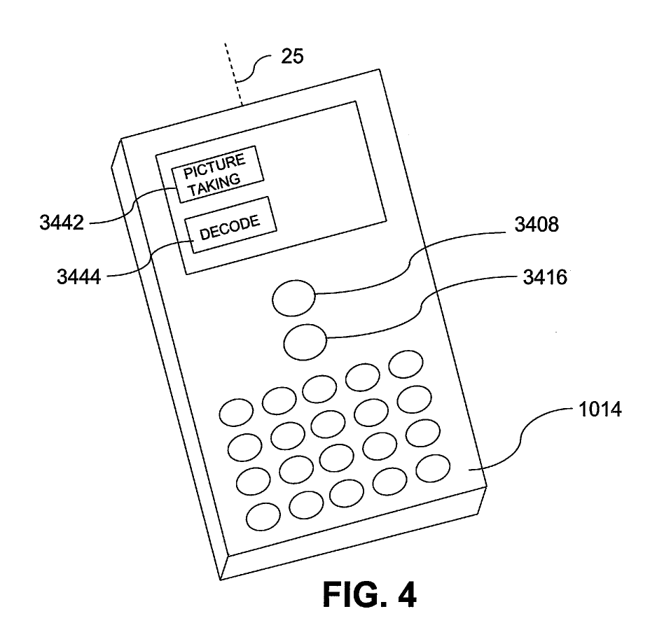

Terminal 1000 as is illustrated in the view of FIG. 4 can include a hand held housing 1014 supporting and encapsulating image sensor 8, lens assembly 100 and the additional components of terminal 1000 designated to be within boundary 1014 of FIG. 3.

In one embodiment, terminal 1000 can have a first operator activated picture taking mode and a second operator activated indicia decode mode. Terminal 1000 can be operative so that image capture and processing can be activated responsively to an operator actuation of trigger 3408 whether a picture taking mode or an indicia decode mode is active. However, terminal 1000 can be operative so that image data processing carried out by terminal 1000 is differentiated depending on which of a first picture taking mode or a second indicia decode mode is active.

A picture taking mode can be activated by selection of displayed button 3442 on display 3420 of terminal 1000. An indicia decode mode can be activated by selection of displayed button 3444 on display 3420 of terminal 1000. Terminal 1000 can be operative so that button 3442 and/or button 3444 can be selected with use of pointer mechanism 3416 of terminal 1000. Terminal 1000 can also be operative so that image capturing and processing can be activated by actuation of trigger 3408 irrespective of whether a picture taking mode or indicia decode mode is active. For example, a default mode can be operative upon actuation of trigger 3408 or sensed conditions can select a mode upon actuation of trigger 3408.

CPU 1060, appropriately programmed can carry out a decoding process for attempting to decode a frame of image data. Terminal 1000 can be operative so that CPU 1060 for attempting to decode a frame of image data can address image data of a frame stored in RAM 1080 and can process such image data. For attempting to decode, CPU 1060 can sample image data of a captured frame of image data along a sampling path (e.g., a column of pixel positions, a row of pixel positions, or a diagonal line of pixel positions). Next, CPU 1060 can perform a second derivative edge detection to detect edges. After completing edge detection, CPU 1060 can determine data indicating widths between edges. CPU 1060 can then search for start/stop character element sequences and if found, derive element sequence characters, character by character by comparing with a character set table. For certain symbologies, CPU 1060 can also perform a checksum computation. If CPU 1060 successfully determines all characters between a start/stop character sequence and successfully calculates a checksum (if applicable), CPU 1060 can output a decoded message. Where a decodable indicia representation is a 2D bar code symbology, a decode attempt can comprise the steps of locating a finder pattern using a feature detection algorithm, locating data lines intersecting the finder pattern according to a predetermined relationship with the finder pattern, determining a pattern of dark and light cells along the data lines, and converting each light pattern into a character or character string via table lookup.

A succession of frames of image data that can be captured and subject to the described processing in terminal 1000 can be full frames (e.g., including pixel values corresponding to each pixel over a predetermined area of image sensor pixel array). A succession of frames of image data that can be captured and subject to the described processing (e.g., frame quality evaluation processing) can also be “windowed frames” comprising pixel values corresponding to less than each pixel over a predetermined area of image sensor pixel array 10 and in some cases less than about 50%, in some cases less than 25%, and in some cases less than 10% of pixels of image sensor pixel array 10. A succession of frames of image data that can be captured and subject to the described processing can also comprise a combination of full frames and windowed frames. A full frame can be captured by selectively addressing for readout of pixels of image sensor pixel array 10 corresponding to the full frame. A windowed frame can be captured by selectively addressing for readout of pixels of image sensor pixel array 10 corresponding to the windowed frame.

Terminal 1000 can capture frames of image data at a rate known as a frame rate. A typical frame rate is 60 frames per second (FPS) which translates to a frame time (frame period) of 16.6 ms. Another typical frame rate is 30 frames per second (FPS) which translates to a frame time (frame period) of 33.3 ms per frame. Alternatively, other frame rates may be used.

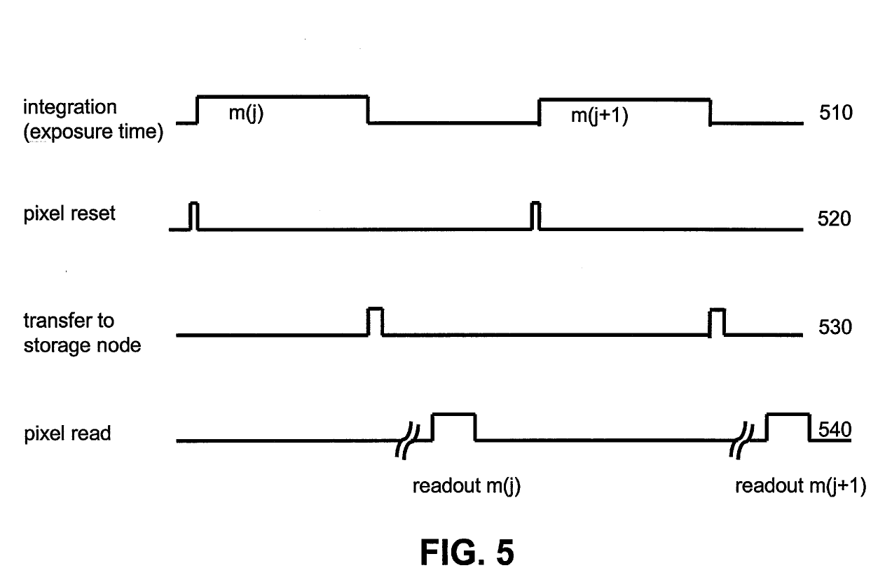

An exemplary global shutter timing sequence is shown in FIG. 5. The global shutter timing sequence shown in FIG. 5 can be used by the imaging terminal 1000 shown in FIG. 3. In global shutter operations, all pixels in an image sensor array can be read simultaneously to generate an image or a frame of image data.

As shown in FIG. 5, a pixel reset operation 520 can be performed to set an image sensor pixel array to a known or prescribed state. The pixel reset operation 520 shown in FIG. 5 resets both the photodiode and a storage node in a pixel configuration. After the pixel reset operation 520, pixels in the image sensor array are allowed to accumulate charge during an integration time 510. Two separate integration times (m(j), m(j+1)) are shown in FIG. 5. At the end of each integration time 510, accumulated charge on the pixels in the image sensor array are simultaneously transferred to a storage node 530 corresponding to each pixel. Then, the stored signal levels are read out 540 from each storage node during an image sensor or pixel read operation. Two image sensor array read operations (readout m(j), readout m(j+1)) are shown in FIG. 5.

The exemplary global shutter control shown in FIG. 5 provides a single reset, single readout sequence.

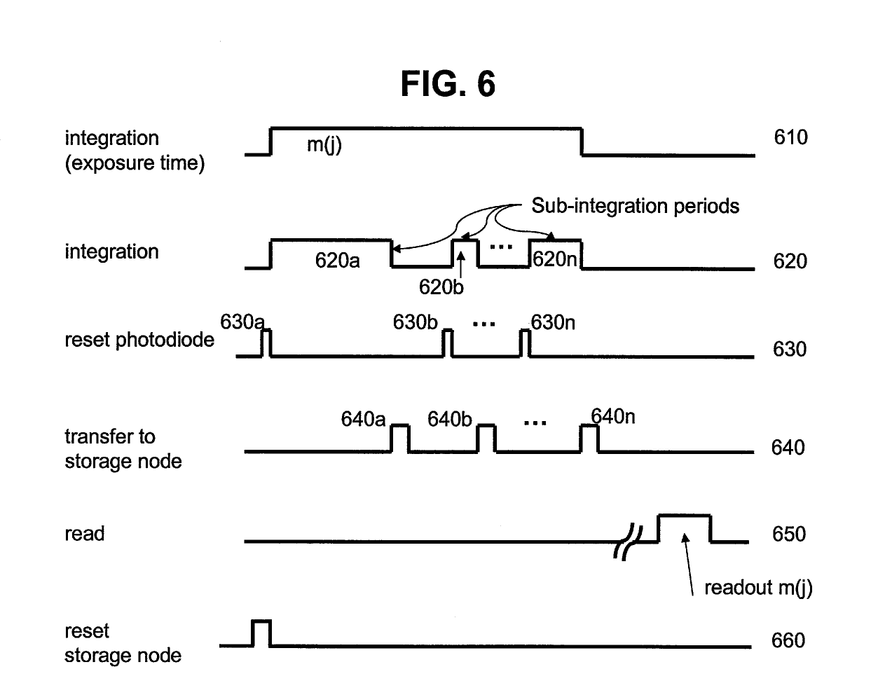

FIG. 6 is a diagram that shows a global shutter timing control sequence according to an embodiment of the application. As shown in FIG. 6, a reset photodiode operation 630 can be performed to set the image sensor pixel array (e.g., photodiodes in image sensor array 10) to a known or prescribed state. Concurrently with an initial reset photodiode operation 630a, a storage node reset operation 660 can reset the storage nodes to a known condition. After the initial reset photodiode operation 630a, pixels in the image sensor array are controllably allowed to accumulate charge within an overall integration time 610.

As shown in FIG. 6, pluralities of sub-integration periods are provided in one embodiment of the global shutter timing control sequence. As shown in FIG. 6, each sub-integration period can be determined by a matching pair of control sequences such as reset photodiode operation (630a, 630b, . . . 630n) and the transfer charge operation (640a, 640b, . . . 640n). Three sub-integration periods are shown in FIG. 6, however, more or fewer sub-integration periods can be implemented. Further, such sub-integration periods (e.g., 620a, 620b, . . . , 620n) can be of equal or different time periods. Upon completion of the integration time 610, accumulated charge transferred to the storage node 630 corresponding to each pixel can be read out 650 using image sensor array read operations as known to one skilled in the art from the storage node. In the embodiment shown in FIG. 6, the photodiode reset and the storage node reset for the pixel configuration can be separated. In the exemplary global shutter timing sequences shown in FIG. 6, a subsequent integration time 610 can be performed (or overlapped) during current pixel read 650 processes.

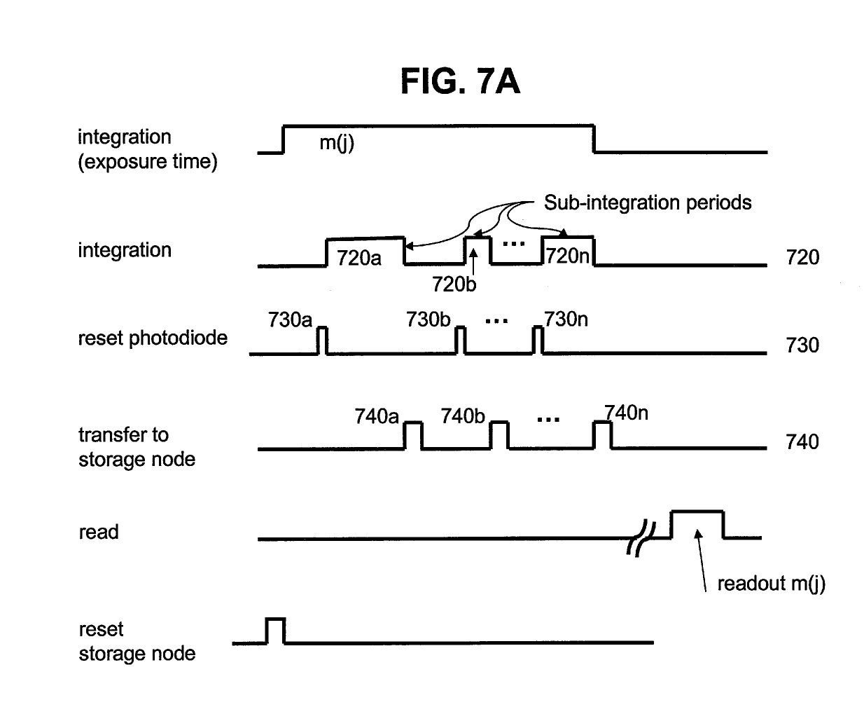

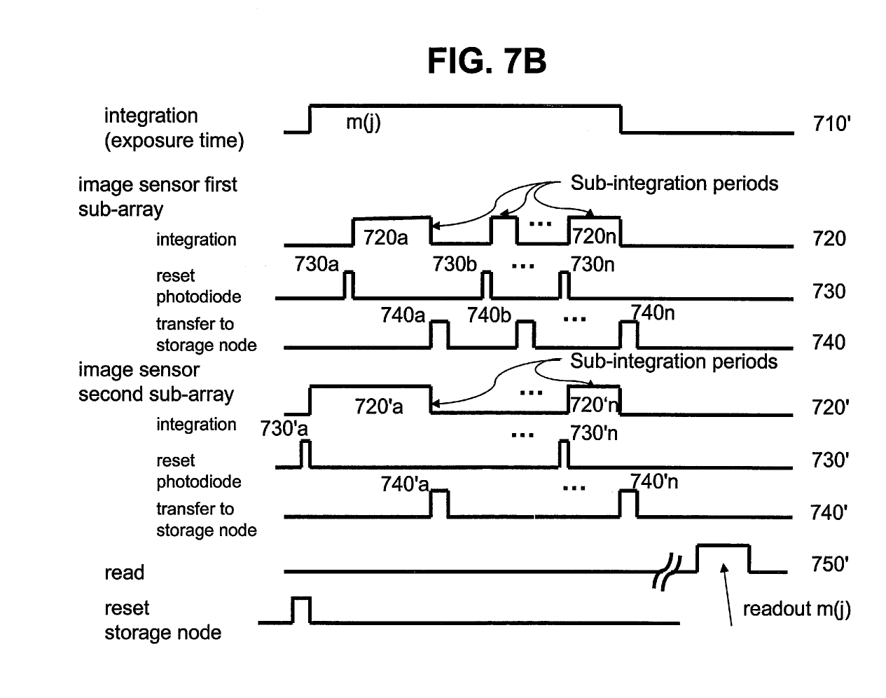

FIG. 7A is a diagram that shows global shutter timing control sequences according to an embodiment of the application. In one embodiment, each sub-integration period can be determined by a matching pair of control sequences such as photodiode operations (730a, 730b, . . . 730n) and transfer charge operations (740a, 740b, . . . 740n). As shown in FIG. 7A, a first sub-integration period 720a does not need to begin at the start of an overall integration time 710. Further, a last sub-integration period does not need to end concurrently with the integration time 710.

In embodiments according to the application, an image sensor can be divided or logically separated into a plurality of sub-arrays or pluralities of pixels. FIG. 7B is a diagram that shows global shutter timing control sequences according to an embodiment of the application. As shown in FIG. 7B, a first plurality of pixels or sub-array (e.g., in image sensor pixel array 10) of an image sensor can be driven by a first plurality of sub-integration periods that are different from a second plurality of sub-integration periods used for a corresponding second plurality of pixels or a second sub-array (e.g., of image sensor pixel array 10) of the image sensor. In one embodiment, each sub-integration period for the first sub-array can be determined by a matching pair of control sequences such as photodiode operations (730a, 730b, . . . 730n) and transfer charge operations (740a, 740b, . . . 740n). Each sub-integration period for the second sub-array can be determined by control sequences such as the reset photodiode operation (730′a, 730′b, . . . 730′n) and the transfer charge operation (740′a, 740′b, . . . 740′n). Three or two sub-integration periods are shown in FIG. 7B, however, more or fewer sub-integration periods can be implemented. Further, such sub-integration periods (e.g., 720a, 720′a, 720n, . . . , 720′n) can be of equal or different time periods. Upon completion of the integration time 710′, accumulated charge transferred to storage nodes corresponding to each pixel can be read out 750′ using image sensor array read operations as known to one skilled in the art from the storage node. In the embodiment shown in FIG. 7B, the photodiode reset, and the storage node reset for the pixel configuration can be separated. In the exemplary global shutter timing sequences shown in FIG. 7B, a subsequent integration time 710′ can be performed during current pixel read 750′ processes.

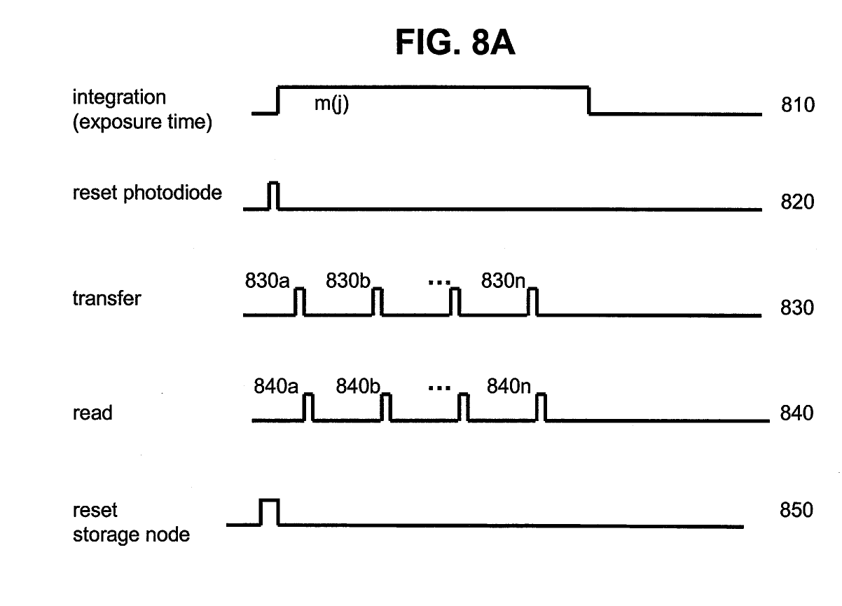

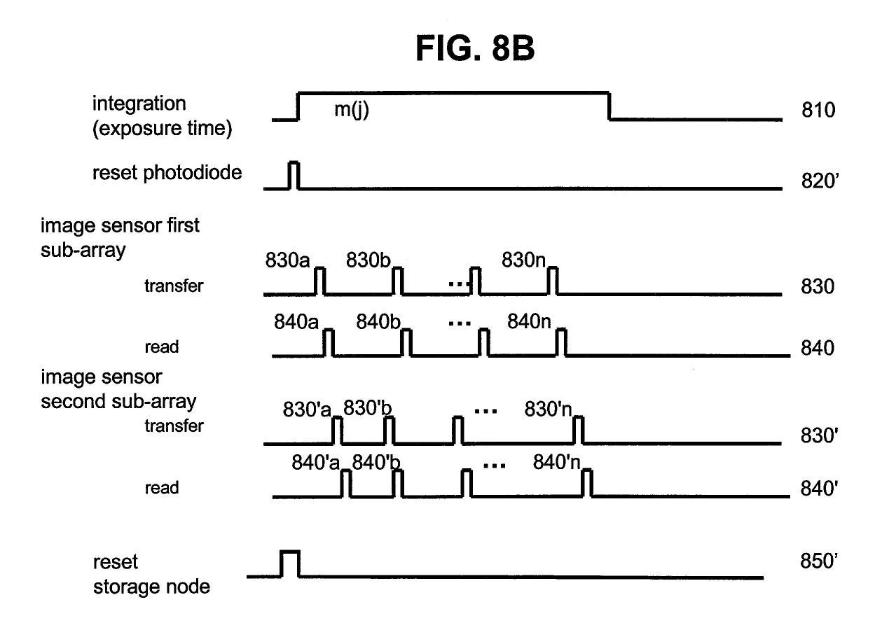

FIG. 8A is a diagram that shows global shutter timing control sequences according to another embodiment of the application. As shown in FIG. 8A, a photodiode reset operation 820 can be performed to set the image sensor pixel array (e.g., all photodiodes in image sensor pixel array 1010) to a known or prescribed state. Concurrently with the photodiode reset operation 820, a storage node reset operation 850 can reset corresponding storage nodes (e.g., all storage nodes in image sensor pixel array 1010) to a known condition.

After photodiode reset operation 820, pixels in the image sensor array are allowed to controllably accumulate charge within each overall integration time 810. As shown in FIG. 8A, pluralities of intermediate frame-read operations can be provided within the global shutter timing control sequence. In one embodiment, each intermediate frame-read operation can be determined by matching control sequences being corresponding intermediate-transfer charge operations (830a, 830b, . . . , 830n) and the intermediate-read operations (840a, 840b, . . . , 840n). Four intermediate frame-read operations are shown in FIG. 8A; however, more or fewer intermediate frame-read operations can be implemented. Further, such intermediate frame-read operations can be of equal or different time periods. Upon completion of the integration time 810, an optional final accumulated charge can be transferred 830 to the storage node corresponding to each pixel. In the embodiment shown in FIG. 8A, the photodiode reset operation 820 and the storage node reset 850 can be separate and independent. In the exemplary global shutter timing sequence in FIG. 8A, a subsequent integration time 810 can be performed during a previous image sensor array read operation.

In embodiments according to the application, an image sensor can be divided into two, three, or more sub-arrays that can use corresponding different plurality of sub-integration periods. FIG. 8B is a diagram that shows global shutter timing control sequences according to another embodiment of the application. As shown in FIG. 8B, a photodiode reset operation 820′ can be performed to set the image sensor pixel array (e.g., all photodiodes in image sensor pixel array 10) to a known or prescribed state. An independent storage node reset operation 850′ can reset corresponding storage nodes (e.g., all storage nodes in image sensor pixel array 10) to a known condition.

As shown in FIG. 8B, pluralities of intermediate frame-read operations can be provided within the global shutter timing control sequence. In one embodiment, each intermediate frame-read operation for the first sub-array can be determined by control sequences such as corresponding intermediate-transfer charge operations (830a, 830b, . . . , 830n) and the intermediate-read operations (840a, 840b, . . . ,840n). Each intermediate frame-read operation for the second sub-array can be determined by corresponding intermediate-transfer charge operations (830′a, 830′b, . . . , 830′n) and the intermediate-read operations (840′a, 840′b, . . . ,840′n). Such intermediate frame-read operations can be of equal or different time periods. Upon completion of the integration time 810, an optional final accumulated charge can be transferred to the storage node corresponding to each pixel. In the exemplary global shutter timing sequence in FIG. 8B, a subsequent integration time 810 can be performed during a previous image sensor array read operation.

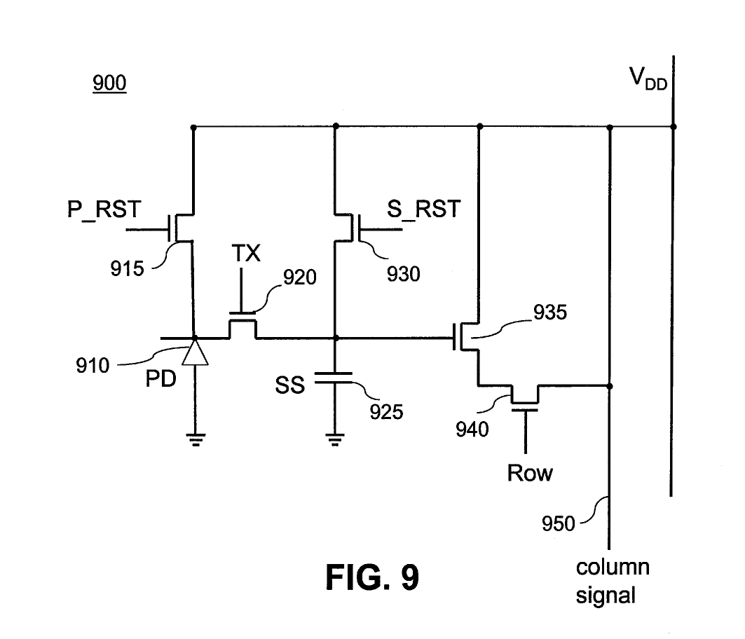

FIG. 9 is a diagram that shows an embodiment of a configuration for pixels in an image sensor array according to the application. As shown in FIG. 9, an embodiment of a pixel configuration 900 can include a photodiode 910, a photodiode reset switch 915 (e.g., transistor), a transfer switch 920 (e.g., transistor), an opaque shielded storage node 925 (e.g., capacitor, floating diffusion, etc.), a storage node reset switch 930 (e.g., transistor), an amplifier 935 (e.g., transistor) and a selection switch 940 (e.g., row selection).

During operations, a photodiode reset transistor (P_RST) can clear any pre-existing charge from the photodiode (PD) or set the photodiode to a prescribed condition. In one embodiment, the photodiode reset transistors can be triggered at the same time (e.g., globally) for all the pixels in the image sensor array. Integration of charges can then occur simultaneously for all pixels after the reset operation is completed. After the integration time, a transfer transistor (TX) can be triggered for all pixels in the image sensor array to concurrently capture a frame of image data. In one embodiment, one or more of such transfer operations can be provided within one integration time. At the completion of the integration time, charge accumulation on photodiodes in the image sensor array stops. Thus, the photodiodes signals can be simultaneously read globally across the sensor array. The row selection transistor (row) is then triggered to transfer the signal charge amplified by the amplifier transistor 935 through the row selection transistor (row) to the column bus 950.

In one embodiment, the storage node 925 is an opaque shielded storage node (SS).

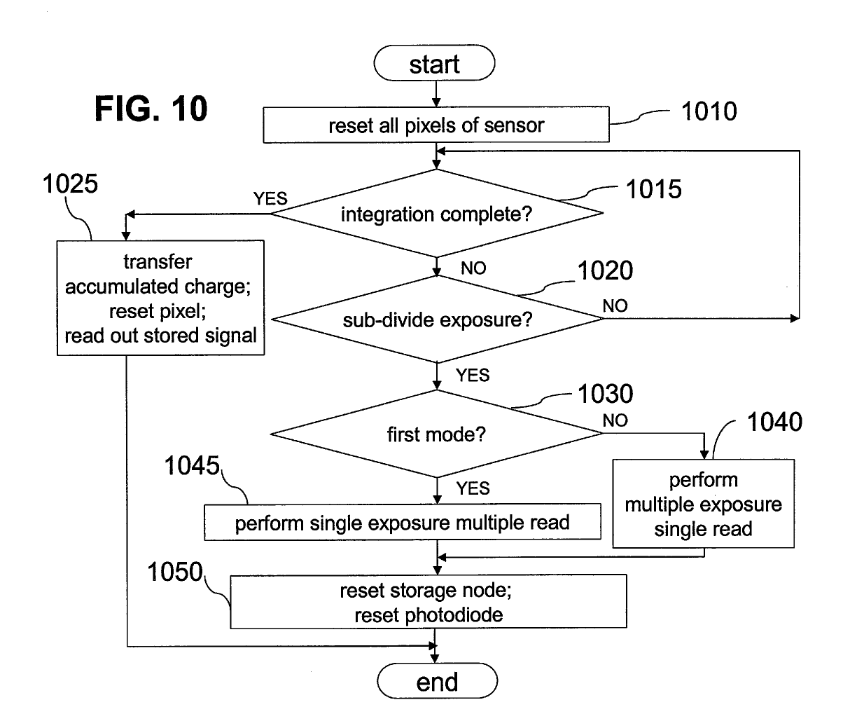

An embodiment of a method of operating an indicia reading terminal according to the application will now be described. The method embodiment shown in FIG. 10, can be implemented in and will be described using a imaging terminal 1000 shown in FIG. 3, however, the method embodiment is not intended to be limited thereby. In one embodiment, a process can begin when a trigger is actuated for inputting image data to the indicia reading terminal 1000.

As shown in FIG. 10, in operation, after a process starts, an indicia reading terminal can reset or clear pre-existing charge from photodiodes for all pixels and corresponding storage nodes in an array forming the image sensor 8 (block 1010).

Then, an integration period or single exposure period for the image sensor can be initiated (e.g., upon a trigger 3408 operation). If the integration period is not complete (operation block 1015), it can be determined whether the integration period is to be subdivided (operation block 1020). If the determination in operation block 1020 is negative, control returns to operation block 1015.

If the determination in operation block 1020 is affirmative, it can be determined whether the imaging terminal is to operate in a first mode being single exposure, multiple read or operate in a second mode being multiple exposure single read (operation block 1030). In the first mode, exemplary operations shown in FIG. 8 can be performed (operation block 1045). Under selected operational conditions or operations, embodiments using the first mode can achieve increased data read rates by processing a frame of image data earlier in the integration time. Otherwise, in the second mode, exemplary operations shown in FIG. 6 can be performed (operation block 1040). Under selected operational conditions or situations, embodiments using the second mode can increase an accuracy in capturing a rapidly moving subject to provide a more accurate image using a frame of image data from one or more sub-integration intervals. From operation block 1040 and operation block 1045, an optional operation to reset storage nodes and photodiodes for the image sensor can be performed (operation block 1050).

When the integration period is determined to be complete in operation block 1015, the accumulated charge from the photodiode can be transferred to the storage mode, the pixel can be reset, and the stored charge can be read out (operation block 1025). From operations blocks 1025 and 1050, the process can end

Embodiments of imaging terminals, image sensor arrays and methods for operating the same can provide alternative and/or advanced global shutter control or operations according to the application.

Although embodiments were described with a single lens system embodiments of the application are not intended to be so limited. For example, two or more lens systems can be used or one lens system can be modified to expose two or more regions of an image sensor.

In one embodiment, first sub-array and second sub-array of an image sensor are contiguous and comprise all pixels in the array forming the image sensor. For example, the second sub-array can include pixels from a subset of columns (or rows) of the image sensor 8. In one embodiment, first sub-array can surround the second sub-array that can include a middle subset of pixels from a plurality of rows and/or columns not along an edge of the image sensor 8. In one embodiment, the first sub-array and the second sub-array are contiguous but can be separated and do not include all pixels in the array forming the image sensor 8. In one embodiment, the first sub-array and the second sub-array are contiguous, adjacent and do not include all pixels in the array forming the image sensor 8. In exemplary embodiment, more than two sub-arrays can be used.

Embodiments according to the application have been described as operating in parallel during multiple subsequent image processes (e.g., exposure periods). However, embodiments according to the application are not intended to be so limited. For example, data readout operations can be performed sequentially after exposure periods.

Although one or more exemplary embodiments were described using a hand held indicia reading terminal and methods for same, the application is not intended to be limited thereto. For example, terminals can include but are not limited to terminals including fixed bar code readers, bi-optic bar code readers and any related type terminals using a plurality of pixels in an image sensor.

According to embodiments of an image sensor, a terminal, and methods for using the same, sub-integration periods (e.g., intermediate readouts) in an exposure time can detect and/or correct characteristic differences within a frame of image data or among adjacent, sequenced, or separated frames of image data. According to embodiments of an image sensor, a terminal, and methods for using the same, sub-integration periods can include durations and/or intervals that can be controlled (e.g., independently and individually) or programmed. In one embodiment, exposure (over/under) in one portion of the array (e.g., first set of pixels) can be compensated to match another portion (e.g., second set of pixels). In one embodiment, image velocity or relative motion (e.g., between) sets of pixel data can be detected and compensated.

Embodiments according to the application (e.g., exposure controller) have been described as operating on individual pixels in an image sensor. However, embodiments according to the application are not intended to be so limited. For example, embodiments such as a controller or image sensor array control circuitry can be configured to control two or more pixels (e.g., adjacent pixels) using a single or shared control line or sub-integration control signal in an integration period.

In embodiments according to the application, an image sensor can be exposed periodically (e.g., j, j+1, j+2 . . . ) in a sequence of exposure periods. In one embodiment, the exposure period is an interval where imaging light is passed via one, two, three, or more lens systems to the image sensor. Alternatively, the exposure period can be a prescribed or variable time interval controlled by the imaging terminal 1000 (e.g., electronically or mechanically) that can be less than or much less than the interval when imaging light is passing through the lens systems.

A small sample of systems methods and apparatus that are described herein is as follows:

A1. An image reading terminal comprising:

a two dimensional image sensor array extending along an image plane, said two dimensional image sensor array comprising a plurality of pixels;

an optical assembly for use in focusing imaging light rays onto the plurality of pixels of said two dimensional image sensor array;

a housing encapsulating said two dimensional image sensor array and said optical assembly;

wherein the terminal is operative in an indicia decode mode in which the terminal, in response to an operator initiated command, captures a frame of image data and processes the frame of image data for attempting to decode a decodable indicia representation;

wherein the terminal is operative in a picture taking mode in which the terminal, in response to an operator initiated command, captures at least one frame of image data for attempting to output an image;

a memory capable of storing said frame of image data, said frame of image data representing light incident on said image sensor array in one integration period; and

a control processor capable of addressing said two dimensional image sensor array, where said control processor is adapted to control multiple exposures of at least one pixel in said two dimensional image sensor array in said single integration period.

A2. The image reading terminal of claim A1, wherein said multiple exposures of at least one pixel in said single integration period comprises multiple resets of a corresponding photodiode for said at least one pixel in said one integration period.
A3. The image reading terminal of claim A1, wherein said multiple exposures of at least one pixel in said single integration period comprises multiple transfers of charge from a corresponding photodiode for said at least one pixel to a shielded storage node in said one integration period.
A4. The image reading terminal of claim A1, wherein said multiple exposures of at least one pixel in said single integration period comprises multiple reads of different stored signal levels of a corresponding photodiode for said at least one pixel in said one integration period.
A5. The image reading terminal of claim A1, wherein said multiple exposures of at least one pixel in said single integration period comprises a resets separated in time for each of a corresponding photodiode and a corresponding shielded storage node for said at least one pixel in said one integration period, where said reset for the corresponding photodiode comprises a plurality of reset operations in said one integration period.
A6. The image reading terminal of claim A1, wherein said image sensor array is configured to provide a plurality of sub-integration periods in said one integration period, where each sub-integration period is determined by a photodiode reset and a subsequent charge transfer from said photodiode to a pixel storage node for each of said plurality of pixels.
A7. The image reading terminal of claim A6, where said sub-integration periods are independently controlled different intervals of time.
A8. The image reading terminal of claim A1, wherein said image sensor array is configured to provide a plurality of pixel reads in said one integration period, where each pixel read is determined by a charge transfer from a photodiode to a pixel storage node and a subsequent output of a signal level representative of accumulated charge from said pixel storage node for each of said plurality of pixels.
A9. The image reading terminal of claim A8, comprising a photodiode reset and a storage node reset before said plurality of pixel reads, where said pixel reads are independent and represent different intervals of time.
A10. The image reading terminal of claim A1, the image sensor including a hybrid monochrome and color image sensor pixel array, the hybrid monochrome and color image sensor pixel array having a first subset of monochrome pixels and a second subset of color pixels in the plurality of pixels.
A11. The image reading terminal of claim 1, comprising an image sensor array control circuit configured to set said integration period within a frame time of a frame rate of the image reading terminal or within a single exposure period of said image sensor array.
A12. The image reading terminal of claim A11, wherein a blanking time is added to the frame time when said one integration period exceeds the frame time, wherein said frame rate of the image reading terminal decreases as said blanking time increases.
A13. The image reading terminal of claim 1, comprising:

control circuitry for outputting data from the plurality of pixels, said control circuitry comprising,
a photodiode;
a photodiode reset switch coupled to the photodiode, a photodiode transfer switch coupled to transfer stored signals from said photodiode,
a shielded storage node coupled to the photodiode through the photodiode transfer switch,
a shielded storage node reset switch coupled to the shielded storage node, and
column and row selection circuitry coupled to the shielded storage node.
   A14. The image reading terminal of claim A1, comprising a plurality of image sensor arrays wherein said multiple simultaneous or asynchronous exposures perform acquisition of a plurality of pixels.
   B1. An indicia reading terminal comprising:

an image sensor array comprising a plurality of pixels;

a housing encapsulating said image sensor array;

an image sensor array control circuit to control multiple exposure times for the plurality of pixels in a frame time of the image sensor array;

an image sensor array readout control circuit to output multiple image data from each of the plurality of pixels from the frame time;

a memory capable of storing said image data; and

a CPU capable of addressing said memory, wherein said CPU is adapted to attempt to decode a decodable indicia represented in said image data.

B2. The indicia reading terminal of claim B1, wherein the image data is a frame of image data representing light incident on the plurality of pixels of said image sensor array, in a portion of an integration time.
B3. The indicia reading terminal of claim B1, wherein said image sensor array is configured to provide a plurality of sub-integration periods in said one integration time within said frame time, where each sub-integration period is determined by a photodiode reset and a subsequent charge transfer from said photodiode to a pixel storage node for said plurality of pixels.
B4. The indicia reading terminal of claim B1, wherein said image sensor array is configured to provide a plurality of pixel reads in a single integration time within, where each pixel read is determined by a charge transfer from a photodiode to a pixel storage node and a subsequent output of charge (signal level) from said pixel storage node for said plurality of pixels.
C1. A method of processing data from an indicia reading terminal including an image sensor array comprising a plurality of pixels, the method comprising:

focusing imaging light rays onto the plurality of pixels of said image sensor array; and

outputting a frame of image data from said plurality of pixels in a single exposure period of the image sensor array, where said outputting comprises,
controlling multiple exposures of at least one pixel in the plurality of pixels in said single exposure period, and
outputting separate data from said at least one pixel for each of said multiple exposures in said single exposure period of the image sensor array.
   C2. The method of claim C1, comprising:

a memory capable of storing said frame of image data,

wherein the terminal is operative in an indicia decode mode in which the terminal, in response to an operator initiated command, captures the frame of image data and processes the frame of image data for attempting to decode a decodable indicia representation;

wherein the terminal is operative in a picture taking mode in which the terminal, in response to an operator initiated command, captures the frame of image data and processes the frame of image data for attempting to output an image or color image data.

While the present application has been described with reference to a number of specific embodiments, it will be understood that the true spirit and scope of the application should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been set forth, it will be understood that features and aspects that have been described with reference to each particular embodiment can be used with each remaining particularly set forth embodiment. For example, features or aspects described using FIGS. 6-8 can be applied to embodiments described using FIG. 3.

We claim:

1. An image reading terminal comprising:
a two dimensional image sensor array extending along an image plane, said two dimensional image sensor array comprising a plurality of pixels;
an optical assembly for use in focusing imaging light rays onto the plurality of pixels of said two dimensional image sensor array;
a housing encapsulating said two dimensional image sensor array and said optical assembly;
wherein the terminal is operative in an indicia decode mode in which the terminal, in response to an operator initiated command, captures a frame of image data and processes the frame of image data for attempting to decode a decodable indicia representation;
wherein the terminal is operative in a picture taking mode in which the terminal, in response to an operator initiated command, captures at least one frame of image data for attempting to output an image;
a memory capable of storing said frame of image data, said frame of image data representing light incident on said image sensor array in one integration period; and
a control processor capable of addressing said two dimensional image sensor array, where said control processor is adapted to control multiple exposures of at least one pixel in said two dimensional image sensor array in said single integration period.

2. The image reading terminal of claim 1, wherein said multiple exposures of at least one pixel in said single integration period comprises multiple resets of a corresponding photodiode for said at least one pixel in said one integration period.

3. The image reading terminal of claim 1, wherein said multiple exposures of at least one pixel in said single integration period comprises multiple transfers of charge from a corresponding photodiode for said at least one pixel to a shielded storage node in said one integration period.

4. The image reading terminal of claim 1, wherein said multiple exposures of at least one pixel in said single integration period comprises multiple reads of different stored signal levels of a corresponding photodiode for said at least one pixel in said one integration period.

5. The image reading terminal of claim 1, wherein said multiple exposures of at least one pixel in said single integration period comprises a resets separated in time for each of a corresponding photodiode and a corresponding shielded storage node for said at least one pixel in said one integration period, where said reset for the corresponding photodiode comprises a plurality of reset operations in said one integration period.

6. The image reading terminal of claim 1, wherein said image sensor array is configured to provide a plurality of sub-integration periods in said one integration period, where each sub-integration period is determined by a photodiode reset and a subsequent charge transfer from said photodiode to a pixel storage node for each of said plurality of pixels.

7. The image reading terminal of claim 6, where said sub-integration periods are independently controlled different intervals of time.

8. The image reading terminal of claim 1, wherein said image sensor array is configured to provide a plurality of pixel reads in said one integration period, where each pixel read is determined by a charge transfer from a photodiode to a pixel storage node and a subsequent output of a signal level representative of accumulated charge from said pixel storage node for each of said plurality of pixels.

9. The image reading terminal of claim 8, comprising a photodiode reset and a storage node reset before said plurality of pixel reads, where said pixel reads are independent and represent different intervals of time.

10. The image reading terminal of claim 1, comprising an image sensor array control circuit configured to set said integration period within a frame time of a frame rate of the image reading terminal or within a single exposure period of said image sensor array.

11. The image reading terminal of claim 10, comprising the image sensor including a hybrid monochrome and color image sensor pixel array, the hybrid monochrome and color image sensor pixel array having a first subset of monochrome pixels and a second subset of color pixels in the plurality of pixels, wherein a blanking time is added to the frame time when said one integration period exceeds the frame time, wherein said frame rate of the image reading terminal decreases as said blanking time increases.

12. The image reading terminal of claim 1, comprising:
control circuitry for outputting data from the plurality of pixels, said control circuitry comprising,
a photodiode;
a photodiode reset switch coupled to the photodiode,
a photodiode transfer switch coupled to transfer stored signals from said photodiode,
a shielded storage node coupled to the photodiode through the photodiode transfer switch,
a shielded storage node reset switch coupled to the shielded storage node, and
column and row selection circuitry coupled to the shielded storage node.

13. The image reading terminal of claim 1, comprising a plurality of image sensor arrays wherein said multiple simultaneous or asynchronous exposures perform acquisition of a plurality of pixels.

14. An indicia reading terminal comprising:
an image sensor array comprising a plurality of pixels;
a housing encapsulating said image sensor array;
an image sensor array control circuit to control multiple exposure times for the plurality of pixels in a frame time of the image sensor array;
an image sensor array readout control circuit to output multiple image data from each of the plurality of pixels from the frame time;
a memory capable of storing said image data; and
a CPU capable of addressing said memory, wherein said CPU is adapted to attempt to decode a decodable indicia represented in said image data.

15. The indicia reading terminal of claim 14, wherein the image data is a frame of image data representing light incident on the plurality of pixels of said image sensor array in a portion of an integration time.

16. The indicia reading terminal of claim 14, wherein said image sensor array is configured to provide a plurality of sub-integration periods in said one integration time within said frame time, where each sub-integration period is determined by a photodiode reset and a subsequent charge transfer from said photodiode to a pixel storage node for said plurality of pixels.

17. The indicia reading terminal of claim 14, wherein said image sensor array is configured to provide a plurality of pixel reads in a single integration time within, where each pixel read is determined by a charge transfer from a photodiode to a pixel storage node and a subsequent output of charge (signal level) from said pixel storage node for said plurality of pixels.

18. A method of processing data from an indicia reading terminal including an image sensor array comprising a plurality of pixels, the method comprising:
focusing imaging light rays onto the plurality of pixels of said image sensor array; and
outputting a frame of image data from said plurality of pixels in a single exposure period of the image sensor array, where said outputting comprises,
controlling multiple exposures of at least one pixel in the plurality of pixels in said single exposure period, and
outputting separate data from said at least one pixel for each of said multiple exposures in said single exposure period of the image sensor array.

19. The method of claim 18, comprising:
a memory capable of storing said frame of image data,
wherein the terminal is operative in an indicia decode mode in which the terminal, in response to an operator initiated command, captures the frame of image data and processes the frame of image data for attempting to decode a decodable indicia representation;
wherein the terminal is operative in a picture taking mode in which the terminal, in response to an operator initiated command captures the frame of image data and processes the frame of image data for attempting to output an image or color image data.
